(19) United States
(12) Patent Application Publication
(10) Pub. No.: US 2023/0115341 A1
(43) Pub. Date: Apr. 13, 2023

(54) Wastewater Treatment Using Lagoons and Nitrification without Subsequent Clarification or Polishing

(71) Applicant: Triplepoint Environmental LLC, Centennial, CO (US)

(72) Inventors: Patrick D. HILL, Lone Tree, CO (US); Braden J. GALBREATH-O'LEARY, Denver, CO (US); Michael C. WEVER, Monticello, FL (US)

(73) Assignee: Triplepoint Environmental LLC, Centennial, CO (US)

(21) Appl. No.: 18/065,828

(22) Filed: Dec. 14, 2022

Related U.S. Application Data
(63) Continuation of application No. 16/935,331, filed on Jul. 22, 2020, now abandoned.
(60) Provisional application No. 62/877,435, filed on Jul. 23, 2019.

(51) Int. Cl. C02F 3/30; C02F 3/08; C02F 3/10

(52) U.S. Cl. CPC C02F 3/303; C02F 3/08; C02F 3/104; C02F 2209/08; C02F 2003/001

(57) ABSTRACT

The disclosed lagoon biological treatment system helps existing wastewater treatment facilities meet stricter discharge permits mandated by the EPA utilizing a facility's existing wastewater treatment infrastructure. Influent is pumped into and processed in an aerated or non-aerated lagoon system, thus initially treating the wastewater to reduce BODS (Biochemical Oxygen Demand) and TSS (Total Suspended Solids) to approximately 20-30 mg/L. Then the wastewater is transferred to and processed in a nitrification reactor, where sufficient nitrifying bacteria is present to reduce nitrogen levels to regulation-acceptable levels without needing to regulate temperature of the water in the nitrification reactor. Wastewater may also be further processed in a denitrifying reactor if necessary to meet local requirement. Post-nitrification polishing of the wastewater is foregone.

### CROSS REFERENCE TO RELATED APPLICATIONS

This application is a continuation of and claims the priority benefit of U.S. application Ser. No. 16/935,331 filed Jul. 22, 2020, the contents of which are incorporated by reference. That application is based on and claims the priority benefit of U.S. provisional application 62/877,435 filed Jul. 23, 2019, the contents of which are incorporated by reference.

### BACKGROUND OF THE INVENTION

It is estimated that approximately one-third of all wastewater treatment facilities in the United States utilize a wastewater lagoon in some capacity during their treatment process. This means that there are more than 6,000 systems employing the use of wastewater lagoons in this country alone. That includes all fifty states, which translates to practically every American watershed, impacting the lives of millions of people nationwide. Lagoons, which can also be found in Canada and other parts of the world, became popular in the 1980's due to their simple design and low maintenance. There are two different types of lagoon treatment processes, one known as a facultative or anaerobic lagoon and one aerated or aerobic lagoon. Facultative lagoon systems are typically comprised of several shallow ponds, 4-6 feet deep, with a typical overall retention time of 180 days. With the absence of oxygen, anaerobic bacteria break down the waste over a longer period of time. The clean effluent water can then be discharged either on a continuous basis or a periodic, controlled, basis. In controlled discharge systems, the water is stored in a separate storage lagoon and only discharged when water temperatures are likely to be warmer, typically spring (April and May) and fall (October and November) depending on the location of the facility and state regulations.

Aerated lagoons are typically deeper, 8-20 feet deep, and rely on either mechanical or diffused aeration for the supply of oxygen and mixing necessary to aerobically break down waste contaminants in the water. With typically 1-4 aeration cells, operated in series or parallel, aerobic lagoons generally have a retention time of anywhere between 20-40 days.

Properly designed lagoon systems can remove the common constituents found in a wastewater discharge permit, including Biochemical Oxygen Demand (BOD5) and Total Suspended Solids (TSS). However, water quality standards imposed by EPA in March 2006 have mandated State environmental regulators to begin imposing strict standards for ammonia (NH3-N), nitrite+nitrate, and total nitrogen (TN) discharge levels on all lagoon systems. This poses a problem for owners of lagoon systems as they were never designed with the intent of meeting stringent ammonia discharge limits.

For most lagoon owners, the existing options for meeting their new discharge permit are either to replace or radically change their entire facility. Many believe that replacing the wastewater lagoon with an advanced treatment system, such as a conventional activated sludge process, is the only way of achieving the lower discharge requirements. However, because advanced biological treatment processes are much more mechanical in their nature and require many more components that are both expensive to purchase and costly to install, this typically results in millions of dollars required for upfront capital costs even for the smallest of facilities. Moreover, with an increase in the amount of mechanical equipment, a facilities operation and maintenance budget often will double or triple in size. The average small community that operates lagoons today does not have large user base to spread these costs out over and, as a result, the cost of building and operating a mechanical treatment system is unfeasible. Indeed, for many of the small communities that still operate lagoon systems, this is undesirable today for many of the same reasons that such a mechanical treatment process was not originally selected: they do not have the financial wherewithal to either purchase or maintain and operate such a facility. Accordingly, there is a need for a biological treatment process that is more cost effective from both a capital and operation cost perspective for existing lagoons to meet their new discharge requirements.

In one known approach to meeting this need, a nitrification reactor has been provided downstream of the lagoon(s). Because it has been believed that the oxidizing activity of the nitrifying bacteria used in the nitrification process requires certain minimum temperatures to be sustained, efforts have been taken to heat or otherwise maintain minimum temperatures of the water being treated. However, further consideration has suggested alternative approaches to meeting this need.

Some post-lagoon nitrification systems have utilized a fixed bed media to provide the substrate for large numbers of nitrifiers to grow. Typically, in these systems coarse or medium bubble aeration (as defined by industry standards) has been utilized to provide the necessary oxygen for the process, with the primary advantage of coarse or medium bubble systems being the relatively low maintenance required, even though the energy efficiency of such aeration is generally low. Moreover, some people having skill in the art have expressed concerns over the long-term potential for clogging in fixed bed media systems as the solids that inevitably come from a lagoon from normal operation and seasonal lagoon turnover could build up in the fixed media over time. This constitutes a potential long-run cost to lagoon owners, as cleaning the media will require substantial manpower and replacement cost.

Alternatively, post-lagoon nitrification systems that use moving bed media within the nitrification reactor have the advantage of being less likely to clog, as the moving bed is highly mixed and solids that enter the reactor from the lagoon tend to pass through it. However, the conventional wisdom regarding moving bed systems is that they require a polishing or clarification step after the reactor because they themselves (i.e., the moving bed systems) either produce solids or allow solids from turnover or algae growth in the preceding lagoon to pass through. Unfortunately, such clarification steps add costs and operational complexity.

Moreover, moving bed systems typically are designed to be filled with forty to fifty percent media, and such fill levels can make it difficult to remove the internal aerators used to oxygenate the water, e.g., to clean the aerators. Therefore, conventional wisdom is to use medium- or coarse-bubble aerators—which are less prone to clogging than fine-bubble aerators are—and simply rely on the action of the media as it “tumbles” within the water column to break up the bubbles into smaller bubbles—which are more effective at oxygenating the water—as the bubbles rise through the water column. In this regard, however, while studies have shown that for moving bed systems using coarse- or medium-bubble aerators with forty to fifty percent media fill, standard oxygen transfer efficiency is improved as compared to systems without any media at all, the levels of standard oxygen transfer efficiency are still significantly less than those that can be achieved using fine bubble aeration. Despite their better oxygen transfer efficiency, however, fine bubble systems tend to be eschewed for use in connection with moving bed systems given their need for more frequent maintenance (e.g., to prevent or eliminate clogging) and the greater difficulty associated with that maintenance due to the substantial media fill percentages.

### SUMMARY OF THE INVENTION

The disclosed system and method is a process and associated apparatus that suitably utilizes either existing or new treatment lagoon infrastructure along with a final, moving-bed nitrification reactor (and possibly a denitrification reactor where regulations require it) without using a final clarifying or polishing reactor, and also without regulating temperature within the nitrification reactor. First, the influent wastewater is transferred into and processed in either an existing or new 1-cell, 2-cell, or 3-cell aerated or non-aerated lagoon system, thus treating the wastewater in order to remove the majority of the BOD5 and TSS, for example down to approximately 20-25 mg/L BOD5 and 20-20 mg/l TSS. Then, effluent from the primary lagoon(s) is transferred into and processed in a nitrification process that is designed to provide the conditions for ammonia removal through nitrification and, subsequently and if necessary to meet local requirements, into a denitrification process for total nitrogen removal. Finally, the effluent water is discharged.

Suitably, this method and system utilize to the fullest extent possible any and all existing infrastructure while adding the minimal amount of equipment necessary to achieve new discharge permits. Because the nitrification reactor is compact, it is likely to fit into existing lagoon sites without the acquisition of new land.

Thus, the method entails treating wastewater in one or more lagoons before processing it in a nitrifying reactor. As necessary, equipment such as mixers or aerators will be added to the preceding lagoon(s) to ensure that BOD5 and TSS are reduced to sufficiently low levels within the lagoons prior to the wastewater entering the reactors. This equipment can be designed to improve aerobic digestion of waste to ensure BOD5 and TSS levels are each about 20-25 mg/L or less, as well as to keep the final lagoon before the reactor (when there are multiple lagoons) from being stratified and suffering from spring or fall turnover (which can temporarily increase the levels of BOD5 and TSS that reach the nitrification reactor). It could also be designed to aid in the mitigation of algae growth, which could cause high levels of BOD/TSS to enter the reactor and affect the reactor effluent.

In lieu of regulating the temperature of water within the nitrifying reactor, the method utilizes high surface area bio-carriers (i.e., bio-carriers providing a surface area on the order of 2000 m²/m³ or higher), which physically support the growth of nitrifying bacteria, coupled with fine-bubble aeration, i.e., aeration using bubbles on the order of 0.5 to 3 mm in diameter as they are produced by the aerators. In this way, even if the bacteria become “sluggish” as temperatures fall and their biological activity decreases, the sheer, overwhelming numbers of nitrifying bacteria that are present in the nitrifying reactor, coupled with the superior oxygen transfer efficiency of fine-bubble aeration, allows ammonia to be reduced to levels required under the revised standards and regulations. And in this regard, certain steps can be taken as described further below to facilitate the use of fine-bubble aeration by facilitating maintenance of the fine bubble-producing aerators.

Furthermore, contrary to conventional wisdom associated with using moving-bed nitrification reactors, a final clarifying or polishing step post-nitrification can be eliminated by taking steps, as alluded to above, to ensure that the wastewater exiting the lagoons has sufficiently reduced levels of BOD5 and TSS. In this way, the reactor is treating more ammonia than BOD5 or TSS, thereby lessening the extent of solids produced by the nitrification reactor that flow downstream and require polishing or clarification to remove. This is in addition to simply reducing the extent of flow-through waste from the lagoon, that simply passes through the nitrification reactor.

By way of example, the bacteria-supporting bio-carriers that may be utilized are known as “moving bed” media. Generally, such media do not clog as they are kept in suspension through high mixing and aeration, which eliminates or significantly reduces the need to clean the media. Moreover, due to the use of high-surface-area media that facilitates the growth of millions of nitrifying bacteria, despite the slow consumption of ammonia when the water being treated is cold (e.g., during the winter, when water temperatures can be as low as 0.1-0.2° C. in northern climates), no temperature regulation may be required, thus saving on energy costs. Finally, by utilizing the lagoons to treat the BOD5/TSS down to low levels as alluded to above, i.e., BOD5 and TSS levels that are each about 20-25 mg/L or less, and/or adding pre-treatment measures to the lagoons, the nitrification reactor can be “reserved” mainly for nitrification purposes and, as a result, solids production is minimized. Therefore, no clarification step may be required, as is otherwise the case with other moving bed media systems.

The method is further improved by using retrievable fine bubble diffusers within the nitrifying reactors. Fine bubble aeration is more energy-efficient and has enhanced nitrification efficacy when combined with high surface area media, which facilitates using lower media fill percentages (on the order of 10-20%). Advances in fine bubble technology and the development of guiderail systems allow for diffusers that can be easily retrieved and reinstalled for maintenance. These systems are also often more cost effective and easier to install. This can be further enhanced by utilizing a dual action aerator, i.e., one that includes fine bubble diffusers with a coarse bubble mixer, thus allowing for enhanced mixing and scouring (i.e., cleaning) of the media.

As a result, the disclosed process allows lagoon facilities to upgrade their treatment capabilities with significantly reduced capital costs while not significantly increasing operating costs.

### BRIEF DESCRIPTION OF THE DRAWINGS

FIG. 1 is a schematic diagram illustrating a wastewater processing facility arranged to implement the inventive method;

FIG. 2 is a schematic diagram illustrating a nitrification reactor utilized in the wastewater processing facility shown in FIG. 1; and

FIG. 3 is a schematic diagram (plan view) illustrating a fine bubble-producing aerator that may be used in the nitrification reactor shown in FIG. 2.

### EXEMPLARY EMBODIMENTS

The present invention provides a method and system for new or existing wastewater lagoon systems, either aerated or non-aerated, to cost effectively meet more stringent effluent discharge requirements, including improving treatment of Ammonia, Nitrite+Nitrate, Total Nitrogen, BOD, and TSS. With the disclosed method, a new or existing lagoon system will be able to accept raw wastewater from either a municipal or industrial source and through both aerobic and anoxic processes, achieve approximate effluent of 20-25 mg/L BOD/TSS, less than mg/L Ammonia, and 5-10 mg/L Nitrate or Total Nitrogen without the need to build a fully mechanical treatment system, such as an activated sludge plant.

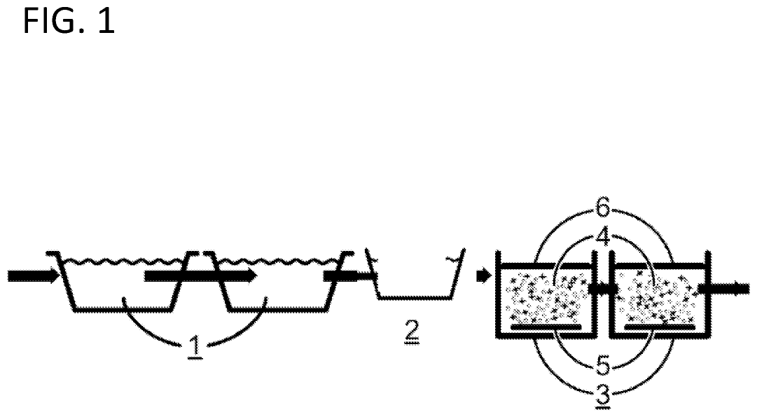

One embodiment of such a system is illustrated in FIG. 1. As illustrated therein, with the present method, first wastewater is introduced into the wastewater lagoon facility where the initial objective is to reduce BOD and TSS to lower levels to promote ammonia removal through nitrification. This happens initially in the lagoon portion 1. Research in the field of activated sludge wastewater treatment has demonstrated that the BOD should be sufficiently reduced to eliminate bacterial competition; generally, achieving a BOD level of 20-25 mg/L (as well as similar level of TSS) is ideal. Most currently existing lagoon systems, if operated according to this method, have the facilities already in place to achieve BOD/TSS removal down to 20-25 mg/L at design flow and loadings. In certain circumstances, additional equipment such as mixers and/or aerators can be added to the lagoon to improve the treatment of BOD, reduce/eliminate spring/fall turnover, and mitigate algae growth. Therefore, the disclosed process can utilize this pre-existing capability to avoid the need to upgrade this component if such an upgrade is not otherwise necessary (e.g., for equipment-related reasons).

There are two benefits to this approach. First, in this initial stage, the lagoon does not absolutely or necessarily have to be aerated; regardless of whether there is partial-mix, complete-mix, or no aeration at all, the disclosed method can achieve the stricter discharge standards. The only requirement is that the new or existing infrastructure be capable of reducing the majority of the BOD/TSS to levels approximately of 20-25 mg/L each, when operated appropriately. As a result, in instances of an existing non-aerated lagoon or a partial mix aerated lagoon, both equipment and energy costs are saved by not needing to install new aeration equipment. Second, because the disclosed method can incorporate this existing infrastructure, as opposed to the activated sludge alternative that replaces it, costs are saved on both equipment and infrastructure. Moreover, operation and maintenance costs remain the same for that portion of the system, giving a measure of predictability for future budgeting. (As alluded to above, it may be necessary or desirable, to achieve adequate treatment prior to the reactor, to install equipment to reduce BOD5, seasonal turnover, and/or algae growth within the lagoon.)

After the wastewater has been initially processed in the lagoon portion 1, it is transferred to the part of the system where ammonia can be removed via nitrification in a nitrification reactor 3, which provides an environment for nitrifying bacteria of various art-known species to nitrify and remove ammonia. Optionally, the wastewater may be treated in a further settling or clarifying lagoon 2 before it is transferred to the nitrification reactor 3, as illustrated in FIG. 1. While some (or even all) of the necessary nitrification can be achieved in the lagoon portion 1 during the summer months, in winter, most of the ammonia removal occurs in this part of the process, i.e., in the nitrification reactor 3.

As illustrated in FIG. 1, the nitrification reactor 3 can include two wastewater tanks operated in series with submerged aeration devices 5 and attached-growth media 4. As noted above, the reactor 3 utilizes media 4 such as “moving bed” media that provides a tremendous amount of surface area (e.g., on the order of 2500 square meters or more of surface area per cubic meter of media) on which the nitrifying bacteria can grow; therefore, a larger bacterial colony can build on it, thus allowing for nitrification to be achieved even at relatively cold water temperatures, e.g., water temperatures as low as 0.1-0.2° C. (For lagoons located in colder climates, typical surface discharge water from the primary treatment section can be less than 1° C. during the winter, so this low temperature nitrification capability is extremely beneficial.) Suitably, the nitrification reactors 3 are on the order of 10% to 50% filled with the media 4, to ensure adequate nitrification capability.

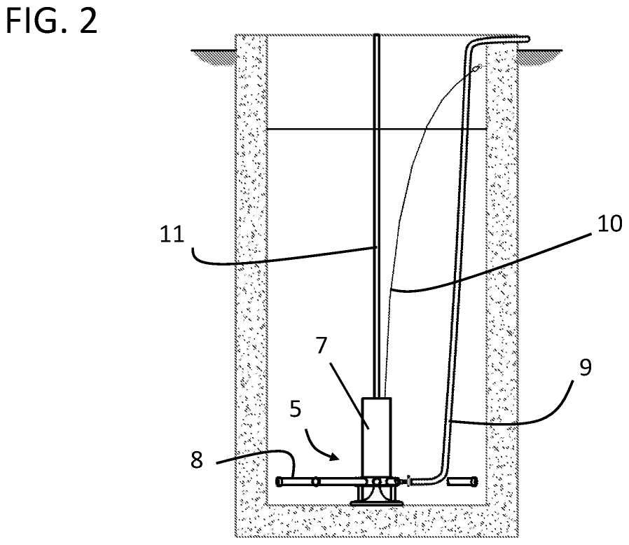

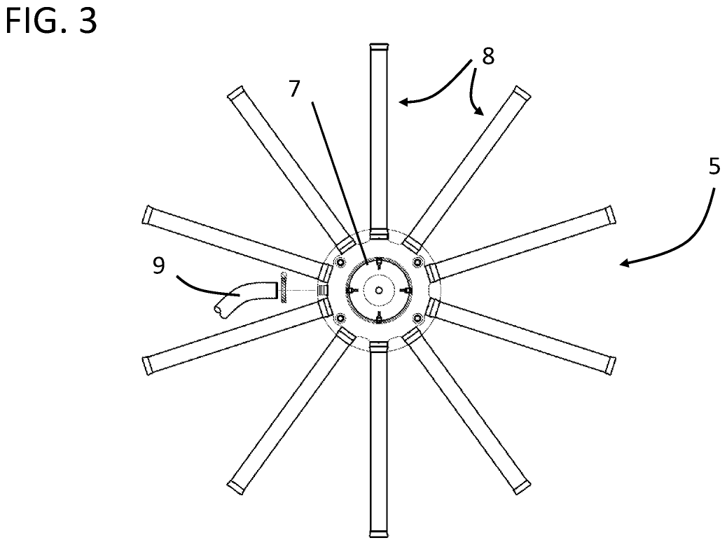

Furthermore, as indicated above, the nitrification reactor 3 is most preferably aerated using aerators 5 that are configured to produce fine bubbles (as defined according to industry standards), i.e., bubbles having diameters on the order of 0.5 mm to 3 mm as produced by the aerators (i.e., before rising within the water column and expanding). In this regard, and as illustrated in FIGS. 2 and 3, the aerators 5 may suitably be constructed as dual-action aerators in accordance with the disclosure of U.S. Pub. 2020/0114319 (co-pending application Ser. No. 16/598,842), the contents of which are incorporated by reference. (FIG. 2 is not to scale, and many more aerators 5—which are not as large relative to the nitrification reactor 3 as the figure suggests—than is shown would be provided.) Such aerators have a central tube 7 designed to release medium or coarse bubbles, which facilitate mixing and movement of the moving bed media 4 within the nitrification reactor 3, and a number of arms 8 extending radially outwardly from a central hub, which arms produce a fizzing “cascade” of fine bubbles. The aerators 5 are provided with air from the surface via an air-supply line 9.

As further indicated above, it may be advisable or even necessary to service such fine bubble-producing aerators 5 more frequently than is the case with respect to medium or coarse bubble-producing aerators, to avoid clogging or fouling of the bubble-producing arms 8. Therefore, to facilitate such servicing of the aerators 5, tethers 10 may be connected to the aerators 5 at one end and connected to an easily accessible location—e.g., a sidewall of the nitrification reaction 3, at a location above the surface of the water being processed within the reactor 3—at the opposite end. Thus, the tethers 10 can be used to pull the aerators 5 up from bottom of the nitrification reactor 3 relatively easily.

Further still, to facilitate maintenance of the aerators 5, it may be advantageous to provide the nitrification reactor 3 with guide rails 11 extending up from the bottom of the nitrification reactor 3 to above the surface of the wastewater within the nitrification reactor 3. As illustrated, the aerators 5 are ideally configured to fit down over the guide rails 11, so that they can be lowered back down into the nitrification reactor 3 after cleaning with the proper placement and orientation of the aerators 5 maintained.

Although the primary mechanism used to achieve mandated discharge levels according to this disclosure is to provide massive amounts of surface area for nitrifying bacteria to colonize in the nitrification reactor (so that sheer volume of bacteria offsets biological slowdown in cold temperatures), the reactors 3 may also be designed to—at least marginally—maintain the water temperature, to ensure the water does not become colder while in the nitrification reactor 3. This can be achieved by utilizing any number of measures that are considered current best practices to prevent cooling and heat loss from the water. For example, the various wastewater tanks can be buried in the ground, thereby utilizing the ground as insulation. Moreover, insulated covers 6, to prevent heat loss due to evaporation and contact with the ambient air, can be provided to cover the various tanks. The specific methods of maintaining water temperature may, of course, depend on the particular needs and conditions of each specific installation.

As noted above, each tank within the nitrification reactor 3 is aerated, and the included moving-bed media may be comprised by small biofilm carriers which yields a very high surface area that provide a habitat for nitrifying bacteria to attach to and grow, thereby exponentially increasing the net rate of biological activity. Air (i.e., oxygen) is supplied to the nitrification reactor 3 by a motor-operated blower (not shown) or equivalent device and is diffused into the wastewater via the aerators 5. The diffused aeration provides oxygen necessary for the nitrifying bacteria to thrive, and it mixes the water to ensure that there are no stagnant areas in the tank. Through the combination of oxygen from the air diffusers, appropriate water temperature as a result of regulation, and attached growth media that promote enhanced bacterial activity and retention time, the nitrification reactor is able to rapidly nitrify ammonia regardless of ambient temperatures.

(One of the benefits of such a nitrification system 3 is very low maintenance and relatively long product life. This is primarily due to the fact that the attached growth media pieces are self-cleaning; as they tumble in the water column, they are constantly hitting against each other, thereby knocking off excess biomass. As a result, maintenance costs are minimized, as no substantial replacement is necessary for approximately 15-20 years.)

After nitrification in the nitrification reactor 3, the water can be directly discharged as effluent. Because the reactor influent water comes from the back end of the lagoon system (including a polishing lagoon 2 if desired, as noted above), where it would normally be discharged, the levels of BOD/TSS are typically lower, below 30 mg/L, or typically low enough to discharge out of the plant. The reactor 30 either does not, itself, add any solids or only adds very minimal solids because the nitrifying bacteria grow a very thin biofilm that does not produce TSS when it dies naturally. This makes the system easier to install, as it can simply be located where the effluent pipe is coming from the lagoon, with minimal piping requirements needed.

Because the lagoon portion 1 can experience turnover in spring/fall, which can temporarily increase the suspended solids in the influent, the TSS of effluent coming out of the lagoon 1 can occasionally exceed 40 mg/L, which could ordinarily be problematic to fixed media systems. In contrast, the moving-bed media utilized within the disclosed reactor 3 will not clog—or it will clog much less frequently, at the very least—as it is constantly in suspension and being thoroughly mixed to ensure that any solids that come in will pass out the discharge. To guard against exceeding permit during times when 40 mg/L TSS effluent may occur due to algae or seasonal turnover, equipment can be added to the lagoon 1, to ensure that the lagoon is continually destratified, so that turnover has less of an effect.

The foregoing disclosure is only intended to be exemplary of the methods and products of the present invention. Departures from and modifications to the disclosed embodiments may occur to those having skill in the art.

The scope of the invention is set forth in the following claims.

We claim:

1. A method for treating wastewater in a treatment system, comprising:
introducing influent wastewater into a lagoon and allowing the wastewater to remain within the lagoon for a period of time to reduce biochemical oxygen demand (BOD5) and total suspended solids (TSS) levels within the wastewater;
after the wastewater has sat for said period of time, transferring partially processed wastewater having reduced levels of BOD5 and TSS from the lagoon to a moving-bed nitrification reactor containing high-surface-area media providing about 2,000 square meters or more of surface area per cubic meter of media;
aerating the wastewater within the moving-bed nitrification reactor by means of fine-bubble aeration;
allowing ammonia levels within the wastewater held within the moving-bed nitrification reactor to be reduced through aerobic, bacterial-based nitrification using nitrifying bacteria that have colonized the high-surface-area media; and
discharging product fluid from the moving-bed nitrification reactor, the product fluid comprising wastewater that has been processed to reduce BOD5, TSS, and ammonia levels to at or below predetermined maximum levels.

2. The method of claim 1, wherein processed wastewater is discharged from the treatment system without clarifying or polishing the product fluid that has been discharged from the moving-bed nitrification reactor to remove solids.

3. The method of claim 1, wherein the temperature of the wastewater within the nitrification reactor is not regulated and is 1° C. or less.

4. The method of claim 1, further comprising treating the wastewater in the lagoon to facilitate reduction of BOD5 and/or TSS.

5. The method of claim 4, wherein the wastewater in the lagoon is aerated.

6. The method of claim 4, wherein the wastewater in the lagoon is mixed.

7. The method of claim 4, wherein the wastewater in the lagoon is covered to retard algae growth.

8. The method of claim 1, further comprising transferring the product fluid from the moving-bed nitrification reactor to a denitrification reactor and allowing nitrate to be removed from the product fluid in the denitrification reactor via anaerobic, bacterial-based denitrification.

9. The method of claim 8, further comprising dosing carbon to the denitrification reactor to support the anaerobic bacteria therein.

10. The method of claim 9, wherein carbon is dosed from a synthetic source.

11. The method of claim 9, wherein carbon is dosed by mixing a portion of influent wastewater with wastewater contained within the denitrification reactor.
